(19) United States
(12) Patent Application Publication
(10) Pub. No.: US 2008/0053911 A1
(43) Pub. Date: Mar. 6, 2008

(54) SEPARATION OF AN ORGANIC PHASE FROM A MIXTURE COMPRISING ORGANIC AND AQUEOUS PHASES BY SOLID PHASE SYSTEMS

(75) Inventor: Ralf Himmelreich, Langenfeld (DE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: QIAGEN GmbH, Hilden (DE)

(21) Appl. No.: 11/468,573

(22) Filed: Aug. 30, 2006

(51) Int. Cl. C02F 1/28

(52) U.S. Cl. 210/691; 210/909; 210/787; 210/359; 210/502.1; 422/101

(57) ABSTRACT

The present invention relates to a method for separation of a mixture comprising an organic and an aqueous phase making use of a solid phase system. Still further the invention refers to a specific solid phase system, namely a spin column which can be used in order to carry out said method in an easy way. According to preferred embodiments the organic phase is phenol or phenol/chloroform.

### FIELD OF THE INVENION

This invention relates generally to a method for separation of a mixture comprising an organic and an aqueous phase. More specifically, it refers to a method making use of a solid phase system. Still further the invention refers to a specific solid phase system, namely a spin column which can be used in order to carry out said method in an easy way.

### BACKGROUND OF THE INVENION

During a lot of preparative as well as analytical working steps, especially in chemical laboratories, the separation of aqueous and organic phases becomes necessary. Such separations may be problematic and difficult, in particular when little amounts of the phases are to be separated.

As an example, the inactivation of enzymatic reactions by phenol extraction or phenol/chloroform extraction of aqueous phases requires the subsequent separation of the phases. For cases of use of small volumes like volumes in the range below 1 mL, it is often difficult to separate the phases by pipetting. A very calm hand is required for the separation and even with taking extreme care it is often not possible to avoid a contamination of the aqueous phase by some amount of the organic phase.

For such cases where phenol or phenol/chloroform phases are present in the mixture it is extremely difficult to get rid of them. Therefore, in certain experiments some effort has been made to replace these compounds in the respective extraction steps or to apply alternative isolation methods, such as extraction of DNA or RNA, respectively, being carried out by column filtration steps.

However, as to one aspect such replacement is not possible for some constellations and still further it may probably not be wanted.

Another approach to separate organic and aqueous phases, in particular phenol/chloroform extractions can be carried out making use of a Phase Lock Gel™ offered by Eppendorf, Hamburg, Germany. Phase Lock Gel™ (PLG) is a product that eliminates interface-protein contamination during phenol extraction. PLG migrates to form a tight seal between the phases of an aqueous/organic extraction upon centrifugation, i.e. the organic phase and the interface material are trapped in or below the barrier. Then, however, it is necessary to transfer the aqueous phase by decanting or pipetting. PLG can be adapted to protocols requiring extraction of an aqueous sample with phenol and/or chloroform, as described by “Murphy, N. R. and Hellwig, R. J. 1996 BioTechniques 21(5): 934-939”.

### The Problem Underlying the Present Invention

As mentioned above, with separation of small amounts of aqueous and organic phases, process steps as pipetting or decanting make the respective method difficult and circuitous. This leads to relatively long durations of the separation processes. It is therefore the object of the present invention to establish a method which is easy to handle while simultaneously ensuring sufficient purity of the separated phases. In particular, phenol and phenol/chloroform extractions should be simplified while being less time consuming. Ideally, small volumes, e.g. volumes below 1 mL, are processed in a relatively short period of time, e.g. in the range of 1 minute.

### SUMMARY OF THE INVENION

The problems noted above are overcome with methods which significantly simplify extractions of mixtures of organic and aqueous phases. Such simplification can be achieved by the method according to the present invention, which makes use of a method for the separation of a mixture of an organic and an aqueous phase. The organic phase is adsorbed by the solid phase system and the desired aqueous phase can be obtained in an easy way avoiding any pipetting or similar difficult preparation steps.

It has surprisingly been found that the method according to the present invention is in particular suited for separation of an organic phase comprising phenol or phenol/chloroform. The method according to the present invention can of course also be applied for separations wherein the organic phases phenol and/or chloroform are not involved.

The invention refers to the following items 1 to 12:

### 1. A method for the separation of a mixture of an organic and an aqueous phase, wherein the organic phase is adsorbed by a solid phase system.

### 2. The method according to item 1, wherein the organic phase comprises an organic solvent, preferably phenol or phenol/chloroform.

### 3. The method according to items 1 and/or 2, wherein the solid phase system comprises a water-insoluble polymer.

### 4. The method according to item 3, wherein the water-insoluble polymer is capable of adsorbing organic solvent.

5. The method according to any of the preceding items, wherein the solid phase system comprises one ore more polymers out of the group consisting of poly(vinylpolypyrrolidone), poly(ethylene-co-acrylic acid) sodium salt acrylic acid wt.-%, poly(vinylidene fluoride), poly(tetrafluorothylene), poly(4-vinylphenol) and poly(styrene-co-maleic anhydride).

### 6. The method according to any of the preceding items, wherein the solid phase system comprises additionally a gel filtration medium.

### 7. The method according to item 6, wherein the gel filtration medium is capable of adsorbing salts from the aqueous phase.

### 8. The method according to any of the preceding items, wherein the solid phase system is incorporated into a spin column.

### 9. The method according to item 8, wherein a mixture of an organic and an aqueous phase is added and a separation step is carried out by centrifugation.

### 10. A spin column comprising a water-insoluble polymer capable of adsorbing organic solvent selected from phenol or phenol/chloroform.

11. The spin column according to item 10, wherein the water-insoluble polymer is one or more selected out of the group consisting of poly(vinylpolypyrrolidone), poly(ethylene-co-acrylic acid) sodium salt acrylic acid 5 wt.-%, poly(vinylidene fluoride), poly(tetrafluorothylene), poly(4-vinylphenol) and poly(styrene-co-maleic anhydride).

### 12. The spin column according to items 10 and/or 11 comprising additionally a gel filtration medium.

### DESCRIPTION OF THE PREFERRED EMBODIMENTS OF THE INVENION

The solid phase system suited to be used in the method according to the invention comprises a water-insoluble polymer being able to adsorb the organic phase. According to a most preferred embodiment, the polymer is able to adsorb phenol or phenol/chloroform.

Suitable polymers for adsorbing the organic phase are for example poly(vinylpolypyrrolidone), (PVPP; CAS number: 25249-54-1); poly(ethylene-co-acrylic acid) sodium salt acrylic acid 5 wt.-%, (PEAA; CAS number: 25750-82-7); poly(vinylidene fluoride), (PVF; CAS number: 24937-79-9); poly(tetrafluoroethylene), (PTFE; CAS number: 9002-84-0); poly(4-vinylphenol), (P4VP; CAS number: 24979-70-2); and poly(styrene-co-maleic anhydride), (PSMA; CAS number: 9011-13-6).

The solid phase system may comprise one or more polymers.

The solid phase system may optionally comprise a gel filtration medium in addition to the polymer in order to adsorb also salts out of the aqueous phase. Suitable substances for that purpose are, for example, the various Sephadex™ or Sephacryl™ gels.

According to an embodiment of the invention the method is carried out using a spin column like small spin column, Qiagen, cat.-No. 79523, or QIAshredder mini columns, Qiagen, cat.-No. 79654 or QIAshredder Maxi Spin Columns as contained in the DNeasy Plant Maxi Kit, Qiagen, cat.-No. 68161, being filled with the solid phase system.

Preferably, the volume of the reservoir of the spin column is from about 1,5 mL to about 8 mL. The use of columns of both ends of this range can be advantageous, depending on the purpose: a small volume guarantees a quick separation, whereas a larger volume leads to a more efficient separation.

By adding the mixture to be separated and subsequent centrifugation the aqueous phase can be simply collected at the outlet of the spin column, preferably in the collection microtube.

Preferably, the method is applied with volumes of 50 to 400 μL of mixtures of organic an aqueous phases, more preferably with volumes of 50 to 300 μL, and most preferably with volumes of 50 to 200 uμ.

### All types of spin columns known in the art are suitable for use in the method according to the present invention.

A spin column pre-filled with a suitable solid phase system as defined according to the present invention is also a subject-matter of this invention. The pre-filled solid phase system is a polymer and can be selected from the polymers described above.

Preferably, the bed of the adsorption medium is from about ½ to about ¾ of the inner volume of the reservoir of the spin column.

### BRIEF DESCRIPTION OF THE DRAWINGS

FIG. 1 shows a longitudinal section of a spin column, as it can be used in the present invention, inserted in a collection microtube (centrifugation tube).

FIG. 2 shows a longitudinal section of the spin column of FIG. 1 before and after centrifugation.

FIGS. 3-5 show longitudinal sections of the spin column of FIG. 1 filled with different solid phase systems according to Example 1 (see below).

FIG. 6 shows a longitudinal section of an alternative embodiment of a spin column.

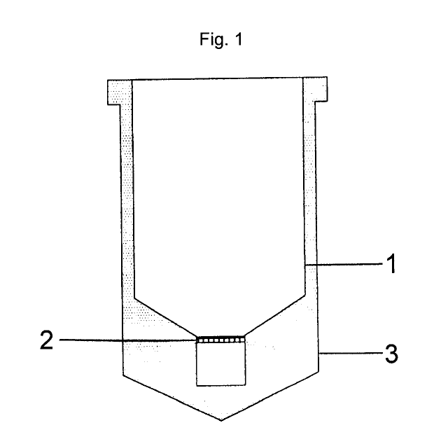

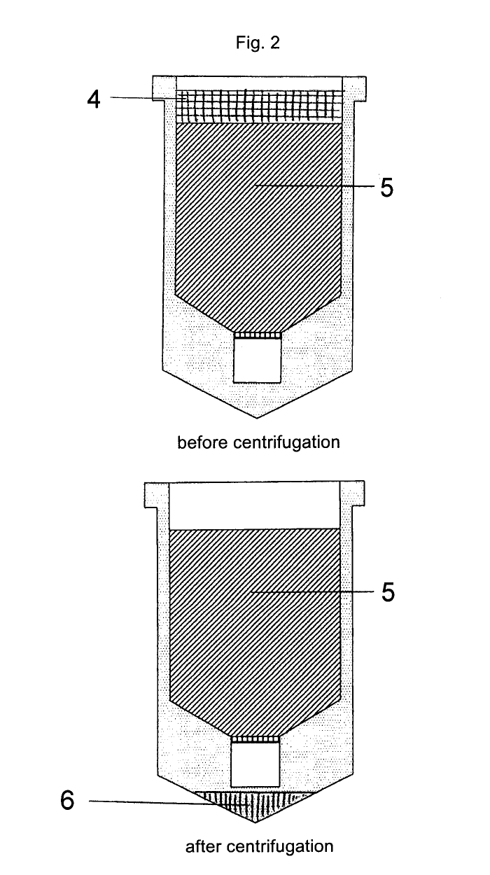

The spin column of FIG. 1 comprises a reservoir 1 for the absorption/filtration medium and a filter 2, which is a barrier for that medium in order to keep it in the column during centrifugation, but which can be passed by the aqueous phase. The two elements are building the spin column, which is removable incorporated in a centrifugation tube 3. After centrifugation of an emulsion 4 of aqueous and organic phase using the spin column filled with a suitable adsorption medium 5 the separated aqueous phase 6 can be collected at the bottom of the centrifugation tube by removing the spin column (see FIG. 2).

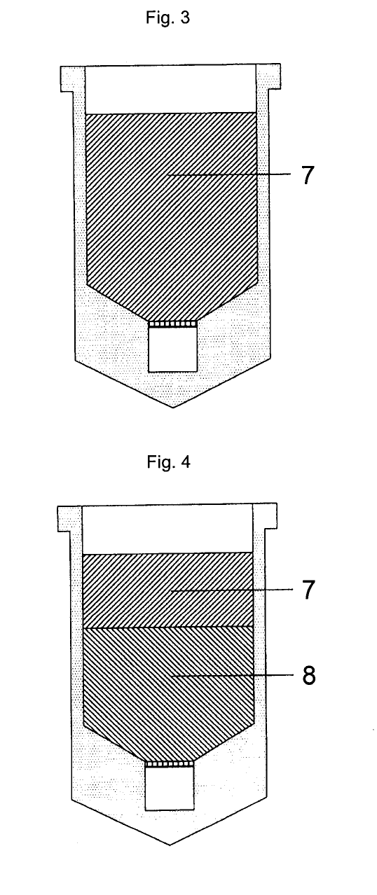

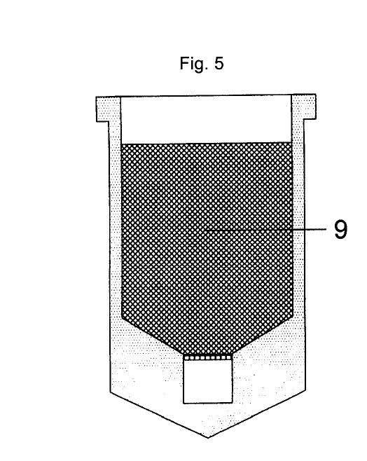

In FIGS. 3-5 the reservoir 1 is filled with Sephadex (7) (FIG. 3), two layers of Sephadex (7) and PVPP (8), which are not mixed (FIG. 4), and a mixture 9 of Sephadex and PVPP (FIG. 5), respectively. Only in the case of the embodiment shown in FIG. 3, there were still two phases in the bottom of the centrifugation tube after centrifugation meaning that Sephadex is not suitable to adsorb the organic phase, while in the cases of the embodiments of FIGS. 4 and 5 there was only the aqueous phase in the bottom of the centrifugation tube (see also Example 1).

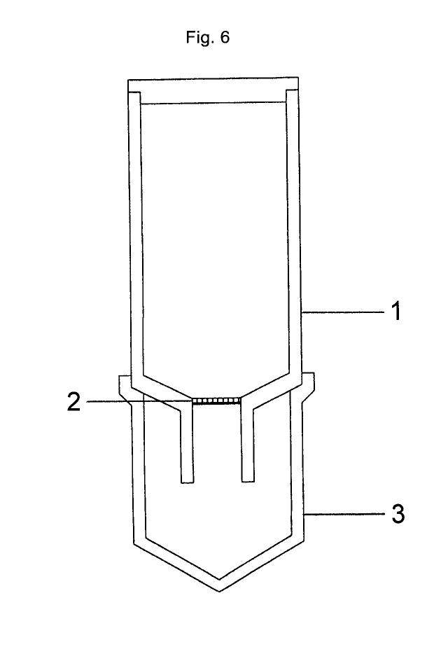

In the alternative embodiment shown in FIG. 6 the spin column, consisting of reservoir 1 and filter 2, is not inserted in but placed on the centrifugation tube.

### Materials and Methods

The following examples do not limit the scope of the invention. The effectiveness of the method according to the present invention is clearly demonstrated:

### Preparation of Spin Columns

A suspension of insoluble polymers in AE buffer (0.5 mM EDTA; 10 mM Tris; pH 9.0) is set up and swollen over night at 4° C.

For the preparation of the spin columns the suspension was homogenized by vortexing and an aliquot was pipetted into the column. The gel bed was formed by a short centrifugation. This pipetting/centrifugation procedure was repeated until the height of the bed made about ¾ of the volume of the inner reservoir of the column.

### EXAMPLE 1

### Phenol Binding Property of Poly(Vinylpolypyrrolidone)

Three spin columns were filled with different solid phase systems:
column A: Sephadex G-10; GE Healthcare; Cat No. 17-0010-01
column B: mixture of Sephadex G-10 and poly(vinylpolypyrrolidone); Sigma-Aldrich Co. Cat No. P6755
column C: two layers of solids: poly(vinylpolypyrrolidone) (below); Sephadex G-10 (above)

On each of the columns A, B and C 200 μL of a mixture of 100 μL water and 100 μL phenol/chloroform was placed. The columns were centrifuged for 30 seconds with 6000 g.

Only in the case of column A with no poly(vinylpolypyrrolidone) being present there was still a two-phase system left after the centrifugation step.

This result shows, that poly(vinylpolypyrrolidone) polymer is suited for adsorption of organic phase like phenol/chloroform and Sephadex G-10 does not lead to a separation.

### EXAMPLE 2

### Extraction of Plasmid DNA and Subsequent Linearization by Restriction

### Extraction:

5 μL pUC21-solution (5 μg pUC21), 10 μL 1M sodium chloride solution and 35 μL TE buffer (1 mM EDTA; 10 mM Tris; pH 7.5) were mixed with 50 μL phenol and 50 μL phenol/chloroform. The mixture was homogenized by vortexing and added to a spin column filled with adsorption medium, which was prepared by mixing the following components:

4 g Sephadex G-25; GE Healthcare; Cat No. 17-0032-01
1 g poly(vinylpolypyrrolidone)
1 g poly(ethylene-co-acrylic acid) sodium salt acrylic acid 5 wt.-%; Sigma-Aldrich Co. Cat No. 426733
in AE buffer (0.5 mM EDTA; 10 mM Tris; pH 9.0)

The column was centrifuged for 30 seconds with 6000 g.

### Restriction:

A mixture of 25 μL of the column flow through, 4 μL 10×reaction buffer, 10 μL BiDest and 1 μL enzyme (1. BamHI; 2. HindIII; 3. Sau3A) was heated for 60 minutes at 37° C. in a water bath.

The results showed that after separation of the plasmid DNA the same could be linearized by restriction endonucleases and that hence a potential rest amount of phenol has got no influence on the enzymatic reaction of the restriction. In addition, it was shown that the salt was efficiently removed during the separation by gel filtration.

### EXAMPLE 3

### Extraction of Linearized Plasmid DNA and Subsequent Ligation

### Extraction:

50 μL linearized pUC21-solution (Example 2) were mixed with 50 μL phenol/chloroform. The mixture was homogenized by vortexing and added to a spin column filled with adsorption medium, which was prepared by mixing the following components:

6 g Sephadex G-10
2 g poly(vinylpolypyrrolidone)
in AE buffer

The column was centrifuged for 30 seconds with 6000 g.

### Ligation:

A mixture of 30 μL of the column flow through, 4 μL 10×reaction buffer, 5 μL BiDest and 1 μL T4 DNA ligase was kept for 150 minutes at room temperature.

The result showed, that after the separation the linearized plasmide DNA could be modified by ligation and a potential rest amount of phenol has got no influence on the enzymatic reaction of a ligation.

### EXAMPLE 4

### Extraction of Genomic DNA and Subsequent PCR Amplification

### Extraction:

100 μL purified human gDNA (160 ng/μL) and 10 μL 5 M sodium chloride solution were mixed with 100 μL phenol/chloroform. The mixture was homogenized by vortexing and added to a spin column filled with adsorption medium, which was prepared by mixing the following components:

6 g Sephadex G-10
2 g poly(vinylpolypyrrolidone)
in AE buffer

The column was centrifuged for 30 seconds with 6000 g.

### Amplification:

After the separation the gDNA could be amplified by PCR. This shows that a potential rest amount of phenol has got no influence on the enzymatic reaction of a PCR.

### EXAMPLE 5

### Comparison of the Duration of Different Separation Methods

Classical phenol extraction: 100 μL sample+100 μL phenol/chloroform; vortexing (10 sec); centrifugation (30 sec); transferring supernatant in fresh tube; adding salt and ethanol; vortexing and centrifugation (10 min); discarding supernatant; adding 70% ethanol; centrifugation (3 min); discarding supernatant; drying pellet (10 min); resuspending in buffer.

Total duration: 25 minutes

Separation with Phase Lock Gel™: prespinning Phase Lock Gel™ tube (20-30 sec; 12000-16000×g); 100 μL sample+100 μL phenol/chloroform; mixing (vortexing not recommended) (10 sec); applying all to the column; centrifugation (5 min; 12000-16000×g); transferring (decanting) supernatant in fresh tube.

Total duration: 6 minutes

Separation according to the invention: 100 μL sample+100 μL phenol/chloroform; vortexing (10 sec); applying all to the column; centrifugation (30 sec; 6000×g).

Total duration: 1 minute

The duration of the separation process is clearly diminished when the method according to the present invention is used.

### REFERENCE NUMBERS

1 reservoir
2 filter
3 collection microtube (centrifugation tube)
4 emulsion of aqueous and organic phase
5 adsorption medium
6 aqueous phase
7 Sephadex
8 PVPP
9 mixture of Sephadex and PVPP

1. A method for the separation of a mixture of an organic and an aqueous phase, wherein the organic phase is adsorbed by a solid phase system.

2. The method according to claim 1, wherein the organic phase comprises phenol or phenol/chloroform.

3. The method according to claim 1, wherein the solid phase system comprises a water-insoluble polymer.

4. The method according to claim 3, wherein the water-insoluble polymer is capable of adsorbing organic solvent.

5. The method according to claim 4, wherein the organic solvent is selected from phenol or phenol/chloroform.

6. The method according to claim 1, wherein the solid phase system comprises one ore more polymers out of the group consisting of poly(vinylpolypyrrolidone), poly(ethylene-co-acrylic acid) sodium salt acrylic acid 5 wt.-%, poly(vinylidene fluoride), poly(tetrafluorothylene), poly(4-vinylphenol) and poly(styrene-co-maleic anhydride).

7. The method according to claim 1, wherein the solid phase system comprises additionally a gel filtration medium.

8. The method according to claim 7, wherein the gel filtration medium is capable of adsorbing salts from the aqueous phase.

9. The method according to claim 1, wherein the solid phase system is incorporated into a spin column.

10. The method according to claim 9, wherein a mixture of an organic and an aqueous phase is added and the separation step is carried out by centrifugation.

11. A spin column comprising a water-insoluble polymer capable of adsorbing organic solvent selected from phenol or phenol/chloroform.

12. The spin column according to claim 11, wherein the water-insoluble polymer is one or more selected out of the group consisting of poly(vinylpolypyrrolidone), poly(ethylene-co-acrylic acid) sodium salt acrylic acid 5 wt.-%, poly(vinylidene fluoride), poly(tetrafluorothylene), poly(4-vinylphenol) and poly(styrene-co-maleic anhydride).

13. The spin column according to claim 11 comprising additionally a gel filtration medium.
